(19) United States
(12) Patent Application Publication
(10) Pub. No.: US 2010/0118301 A1
(43) Pub. Date: May 13, 2010

(54) SYSTEM FOR ANALYZING A SAMPLE OR A SAMPLE COMPONENT AND METHOD FOR MAKING AND USING SAME

(75) Inventors: Jan Vondras, JM Delft (NL); Sean Rick, Cypress, TX (US)

Correspondence Address: GUNN, LEE & CAVE, P.C., 300 CONVENT ST., SUITE 1080, SAN ANTONIO, TX, 78205, US

(73) Assignee: PETROLEUM ANALYZER COMPANY, L.P., Houston, TX (US)

(21) Appl. No.: 12/270,800

(22) Filed: Nov. 13, 2008

(51) Int. Cl. G01J 3/30; G01C 25/00

(52) U.S. Cl. 356/318; 702/104

(57) ABSTRACT

A system and associated method are disclosed for analyzing a sample or sample component including species capable of producing fluorescent light when excited by a light source, where the light source comprises an excimer light source having a high voltage power supply with voltage and current regulation circuitry.

### BACKGROUND OF THE INVENTION

1. Field of the Invention

The present invention relates to a system or apparatus for analyzing a sample or a sample component including a fluorescence detection subsystem and to methods for making and using same.

More particularly, the present invention relates to a system or apparatus for analyzing a sample or a sample component and to methods for making and using same, where the system in certain embodiments includes a fluorescent detection subsystem including high voltage, high frequency current and voltage controlled power supply, a software detection correction assembly and a light sources including an excimer light source or lamp.

2. Description of the Related Art

UV fluorescence is a general technique used to detect and quantitatively determine sulfur contents of samples. Most current fluorescent instruments use broad spectrum light sources equipped with filters designed to a narrow wavelength or frequency range of light that is designed to interact with the sample. Generally, the light interacts with fluorescently active compounds in the sample or sample component in a light chamber, where the sample can be supplied directly to the chamber, via a sample loop, or from a chromatography column.

Beside broad spectrum light sources, atomic vapor lamps have been used for light sources. These lamps have a narrower wavelength or frequency range and require less filtering, but these lamps are prone to a steady decrease in light production over time. Such reduction in light production over time causes problems in instrument stability and problems in reducing the detection limit of the instrument. For UV fluorescence detection, zinc, cadmium and other metal lamps have been used as light sources. However, many of these lamps generate light that is less than optimal for the detection of certain species such as UV fluorescence detection of SO₂. SO₂ absorbs UV light between about 190 nm and 230 nm. NO also absorbs UV light in the range, but the NO absorption spectra has a gap (does not absorb light) between about 215 nm and 225 nm. While zinc lamp generates light centered at 220 nm, the generated light is broader than 220 nm even with filtering and includes light capable of exciting NO, which interferes with SO₂ detection.

In U.S. Pat. No. 7,268,355, a UV fluorescent instrument was disclosed using a specifically designed excimer lamp as a light source. The lamp used a mixture of krypton and chlorine, which generates light in a narrow wavelength range centered at about 222 nm.

Although an excimer light source or lamp has been disclosed for use in analytical instruments, there is a need in the art for improved excimer light sources or lamps for use in UV fluorescent instruments, and especially instruments that include fluorescent light sources such as excimer light sources or lamps having voltage and current control subsystems and/or software detection signal adjustment subsystems to improve instrument stability and reliability and to reduce the detection level for total sulfur and/or total nitrogen.

### SUMMARY OF THE INVENTION

Embodiments of the present invention provide a system or apparatus for analyzing a sample or sample component including a sample delivery subsystem, optionally an oxidation subsystem, a detection subsystem and an analyzer subsystem. The sample delivery subsystem can comprise a direct injection assembly, a sample loop assembly, in-line sampling assembly, a chromatography unit (e.g., GC, LC, HPLC, etc.) or any other sample separation unit. The oxidation subsystem includes a combustion tube having an oxidation zone, where the oxidation subsystem is capable of substantially completely converting all oxidizable sample components into their corresponding oxides. The detection subsystem comprises a light source including a high frequency and high voltage power supply having tight current and voltage control, optionally a software detection signal adjustment subsystem, a detection chamber, and a detector. The analyzer subsystem generally includes a digital processing unit (which can be a computer), a memory, a display, a print, a mass storage device, communication hardware and software, other known peripheries and software for receiving and analyzing a detector signal. The light source can be a filtered broad spectrum light source such as a metal vapor lamp, a gas lamp or other broad spectrum light source, a filtered or unfiltered excimer light source, or a filtered or unfiltered laser light source.

Embodiments of the present invention also provide a system or apparatus for analyzing a sample or sample component including a sample delivery subsystem, an oxidation subsystem, a detection subsystem and an analyzer subsystem. The sample delivery subsystem can comprise a direct injection assembly, a sample loop assembly, in-line sampling assembly, a chromatography unit (e.g., GC, LC, HPLC, etc.) or any other sample separation unit. The oxidation subsystem includes a combustion tube having an oxidation zone, where the oxidation subsystem is capable of substantially completely converting all oxidizable sample components into their corresponding oxides. The detection subsystem comprises a light source including a high frequency power supply having tight current and voltage control, optionally a software detection signal adjustment subsystem, a detection chamber, and a detector. The analyzer subsystem generally includes a digital processing unit (which can be a computer), a memory, a display, a print, a mass storage device, communication hardware and software, other known peripheries and software for receiving and analyzing a detector signal. The light source can be a filtered broad spectrum light source such as a metal vapor lamp, a gas lamp or other broad spectrum light source, a filtered or unfiltered excimer light source, or a filtered or unfiltered laser light source.

Embodiments of the present invention also provide a method for analyzing a sample or sample component including the step of supplying a sample to a system of this invention. The method may also include the step of separating the sample into components. The method may also include the step of oxidizing the sample or sample components into their corresponding oxides prior to fluorescent detection. Once the sample or sample component is in a proper state for detection, the sample or sample component is then forwarded to a detection subsystem, where the sample or sample component enters a fluorescent reaction chamber, where it absorbs light from a light source. A portion of the sample or sample component is converted to an excited sample or an excited sample component. A portion of the excited sample or the excited sample component then fluoresces and a portion of the fluorescent light exits the light reaction chamber through a detector port entering into a detector. The detector converts a number of photon entering the detector (fluorescent light intensity) into a proportional electric signal. The electrical signal is then analyzed in the analyzer and related back to a concentration of the fluorescently active species in the sample or component, and ultimately to a concentration of an atomic species such as sulfur, nitrogen, etc. in the sample or sample component. The light source can be a filtered broad spectrum light source such as a metal vapor lamp, a gas lamp or other broad spectrum light source, a filtered or unfiltered excimer light source, or a filtered or unfiltered laser light source.

For example, if the fluorescently active species is sulfur dioxide (SO₂), then the electrical signal is proportional to the amount of sulfur dioxide in the light reaction chamber and ultimately to the amount of sulfur in the sample or sample component. If more than one sample component includes sulfur, then the sum of the concentration of sulfur in each component containing sulfur yields the total sulfur content in the sample. If the sample included sulfur dioxide as a component, then the signal is directly proportional to concentration of sulfur in the sample. If the original sample includes chemically bound sulfur or a combination of sulfur dioxide and chemically bound sulfur, then the subsystem includes an oxidization subsystem that converts chemically bound sulfur into sulfur dioxide. If the sample includes chemically bound nitrogen, then NO can be determined by ozone induced chemiluminescence subsystem. In certain embodiments, the NO chemiluminescence upstream of the UV detection subsystem.

The present invention also provides a method for performing chromatographic analyses including the step of supplying a sample from a sample delivery system into the a separation unit under conditions to affect a given separation of the sample into components. After separation, the sample components are forwarded to the detector assembly. Optionally, the components may first be oxidized in a combustion assembly. In the detector assembly, the component is brought into contact with light from a light source (in certain embodiment the light source comprises a light source or lamp) in a light reaction chamber, where a portion of a fluorescently active species is excited and a portion of the excited species fluoresce. A portion of the fluorescent light exits the chamber via a detector port into a detector to produce an output electrical signal. The electrical signal is converted into a concentration of the fluorescently active species and, in turn, into a concentration of a corresponding atomic component of interest in the sample, such as sulfur or nitrogen. If the active species is sulfur dioxide, then the analyzer can produce a concentration of sulfur in each component and a total concentration of sulfur in the sample. The light source can be a filtered broad spectrum light source such as a metal vapor lamp, a gas lamp or other broad spectrum light source, a filtered or unfiltered excimer light source, or a filtered or unfiltered laser light source.

### BRIEF DESCRIPTION OF THE DRAWINGS

The invention can be better understood with reference to the following detailed description together with the appended illustrative drawings in which like elements are numbered the same:

FIG. 1A depicts an embodiment of a system of this invention including a fluorescent detection subsystem.

FIG. 1B depicts another embodiment of a system of this invention, including an oxidation subsystem and a fluorescent detection subsystem.

FIG. 1C depicts another embodiment of a system of this invention, including an oxidation assembly, a chemiluminescent subsystem and a fluorescent detection subsystem.

FIG. 2A depicts an embodiment of a fluorescent detector subsystem of this invention.

FIG. 2B depicts another embodiment of a fluorescent detector subsystem of this invention.

FIG. 2c depicts another embodiment of a fluorescent detector subsystem of this invention.

FIG. 3 depicts an embodiment of an high voltage power supply of this invention.

FIG. 4A depicts an embodiment of an oxidizing subsystem of this invention.

FIG. 4B depicts another embodiment of an oxidizing subsystem of this invention.

FIG. 4C depicts another embodiment of an oxidizing subsystem of this invention.

FIG. 5 depicts an embodiment of a chemiluminescent detector subsystem of this invention.

FIGS. 6A & B depict longitudinal and lateral cross-sectional views of an embodiment of an excimer light source of this invention having a straight outer reflective electrode.

FIGS. 6C & D depict longitudinal and lateral cross-sectional views of another embodiment of an excimer light source of this invention having a tapered outer reflective electrode, where the taper is designed to increase light exiting the light source.

FIGS. 6E & F depict longitudinal and lateral cross-sectional views of another embodiment of an excimer light source of this invention having a tapered outer reflective electrode, where the taper is designed to increase light exiting the light source.

FIG. 7A depicts an output spectrum of an excimer lamp or light source of this invention from 200 nm to 900 nm.

FIG. 7B depicts an expanded output spectrum of an excimer lamp or light source of this invention from 200 nm to 250 nm.

### DETAILED DESCRIPTION OF THE INVENTION

The inventors have found that a system or apparatus for analyzing a sample or sample component can be constructed using a specially designed excimer light source, which emits a very narrow wavelength range (even a near monochromatic range) of light centered at a wavelength designed to provide selective excitation of a fluorescently active analyte, without exciting other potentially interfering compounds. For example, an apparatus designed for sulfur or total sulfur analysis using a light source designed to electively excite SO₂ with minimal excitation of NO, a species that interferes with the SO₂ fluorescent detection. The inventors have also found that the system can include a software detection signal adjustment subsystem adapted to improve instrument stability and reliability and to reduce detection limits of the analyte for which the light source is designed. The inventors have found that the software detection signal adjustment subsystem can be used with any light source include an excimer light source. For example, if the analyte is sulfur dioxide, then the light source should be capable of producing light tightly centered around 222 nm. In the case of an excimer light source, the source includes a gas mixtures capable of generating light centered at about 222 nm. If the instrument is intended for analyzing another fluorescently active species, then the excimer light source includes a gas mixture capable of generating light centered at a wavelength within the absorption spectrum of the species.

For additional details of fluorescent detection and chemiluminescent, the reader is referred to the following patents and patent applications Ser. Nos. 4,904,606, 4,914,037, 4,916,077, 4,950,456, 5,916,523, 6,075,609, 6,143,245, 6,458,328, 6,636,314, 7,018,845, 7,244,395, 7,291,203, 10/970,686, 10/970,353, 11/949,610, 11/834,495, 11/834,509, and 11/834,514, incorporated herein by reference. Several of these patent and applications relate to improvements in oxidizing subsystem design, in fluorescent subsystem design, in chemiluminescent subsystem design, and in general in the area of fluorescent and chemiluminescent measurements of sulfur and/or nitrogen in samples and sample components.

In certain embodiments, the present invention broadly relates to a system or apparatus for analyzing a sample or sample component using fluorescence spectroscopy. The apparatus includes a sample delivery subsystem, which can be a direct delivery subsystem or a sample separation subsystem. The system can optionally include an oxidation subsystem for oxidizing oxidizable component of the sample to their corresponding oxides, where one or more of the oxides can be a fluorescently active species when exposed to light of the proper frequency or frequency range. The system also includes a detection subsystem for detecting fluorescent light emitted by excited fluorescently active species in the sample, components or oxides after exposure to the excitation light. The system also includes an analyzer subsystem, where the analyzer subsystem generally includes a digital processing unit (which can be a computer), a memory, a display, a print, a mass storage device, communication hardware and software, other known peripheries and software for receiving and analyzing a detector signal. The sample delivery subsystem can comprise a direct injection assembly, a sample loop assembly, a gas chromatography unit, a liquid (regular performance, medium performance or high performance) chromatography unit, an electrophoresces unit or any other sample separation unit. The detection subsystem includes a light source apparatus, a detection chamber, a detector, and a software detection signal adjustment subsystem. The light source apparatus comprises a high frequency power supply adapted to tightly control supply voltage, frequency and/or current and to power a light source such as a metal vapor lamp, a gas lamp, an excimer lamp or a laser.

In other embodiments, the present invention also broadly relates to a method for performing chromatographic analyses including the step of supplying a sample to a detector assembly. In certain embodiments, the sample is supplied directly to the detector assembly using a direct delivery assembly. In other embodiments, the sample is first separated into components in a separation unit under conditions to affect a given separation of the sample into components prior to supplying the sample components to the detector assembly. In other embodiments, the sample or sample components are oxidized in an oxidation assembly adapted to convert all oxidizable species in the sample or sample components into their corresponding oxides. In the detector assembly, the sample, sample component, oxidized sample, or oxidized sample component is brought into contact with light from a light source in a light reaction chamber, where a portion of a fluorescently active species is excited and a portion of the excited species fluoresce. A portion of the fluorescent light exits the chamber via a detector port into a detector to produce an output electrical signal. The electrical signal is converted in the analyzer into a concentration of the active species in the sample, sample component, oxidized sample, or oxidized sample component. The information can then be used to determine the concentration of an atomic component in the entire sample and/or each sample component.

The systems are especially well suited for UV fluorescence chromatography, where the system includes a UV fluorescent detection subsystem. The detection subsystem includes an excimer light source having a high frequency power supply, a detection chamber, a detector, and a software detection signal adjustment subsystem. The excimer light source is designed to generate light of a very narrow frequency or wavelength range within the UV spectrum of the electromagnetic spectrum centered at a wavelength that results in efficient excitation of a desired analyte, while minimizing excitation of interfering species. For example, a krypton-chloride excimer light source emits light centered at 222 nm, which is centered in a gap between absorption bands of NO absorption spectrum. After filtering, the light generated by a krypton-chloride excimer light source is well suited for selective excitation of SO₂, while minimizing excitation of NO. However, the system and method can also be practiced with metal vapor lamps, gas lamps, and lasers.

In embodiment of this invention, the light source is an excimer light source. The excimer light sources are generally of an elongated toroidal shaped dielectric barrier discharge gas enclosure including an inner throughbore and a discharge gap. The gas enclosure is adapted to be filled with a gas or gas mixture, where light is produced either by a atomic species or an excimer formed from the gases in the enclosure. An excimer is a multi atom complex or molecular complex, where at least one of the atoms or molecules is in an excited states. This complex then emits light. Depending on the excimer, part of the emitted light will be narrowly centered at a specific wavelength or frequency.

The excimer light sources also include a first electrode disposed in the inner throughbore or disposed on an inner surface of the inner throughbore. The excimer light sources also include a light outlet port comprising an end of the enclosure through which light exits the excimer light source. The excimer light sources also include an outer reflective electrode disposed on an exterior surface of the enclosure, where the outer reflective electrode can be tapered or untapered. The outer reflective electrode is designed to concentrate and increase light exiting the light output port. The inner and the outer electrodes are electrically connected to an excimer excimer light source high frequency, high voltage power supply.

The power supply assembly applies a potential across the electrodes sufficient to cause the dielectric barrier to breakdown in a controlled manner. The controlled breakdown result in the formation of micro electrical discharges across the gap. These micro discharges excite the gas or gas mixture producing excited species that then emit a very narrow frequency range of light due to the purity of the emitting species.

In embodiments designed for sulfur dioxide detection, the gas in the enclosure comprises a mixture of krypton and chlorine, which forms a kyrpton-chloride excimer or exciplex upon excitation by the micro electrical discharges across the gap. By controlling the composition of the gas mixture and the pressure of the mixture in the enclosure, the krypton-chloride (KrCl) excimer light source can be tuned to produce light tightly centered at 222 nm, ideal for sulfur dioxide fluorescence detection at a given output intensity. Although a KrCl excimer light source generates light mainly centered at 222 nm, under certain conditions light of longer wavelengths are also produce. In certain embodiments, the excimer light is passed through an excitation light filter to reduce or eliminate these longer wavelengths of produced light.

In all the systems of this invention, the detection subsystems can optionally include a light or optical filters interposed between the fluorescence reaction chamber and the light source and between the fluorescence reaction chamber and the detector. In all the systems of this invention, the fluorescence reaction chamber includes a sample inlet and a sample outlet. The fluorescence reaction chamber also includes a light inlet port and a fluorescent light outlet port, where the fluorescent light outlet port is disposed at an angle relative to the inlet port, where the angle is adapted reduce or eliminate excitation light from entering the light outlet port. In certain embodiments, the angle is between about 60° and about 120°. In other embodiments, the angle is between about 70° and about 110°. In other embodiments, the angle is between about 80° and about 100°. In other embodiments, the angle is between about 85° and about 95°. In other embodiments, the angle is about 90°. The fluorescence reaction chamber can also be mirrored as set forth in U.S. Pat. Nos. 6,075,609 and 6,636,314, incorporated herein by reference.

For systems that include an oxidation subsystem, the sample or sample components are forwarded to a combustion chamber. The combustion chamber includes a sample inlet and an oxidizing agent inlet and an oxidized sample outlet. The sample and oxidizing agent can be simultaneously introduced into the combustion chamber or separately introduced. In certain embodiments, the oxidizing agent is sequentially supplied to the combustion chamber. In certain embodiments, an inert gas can also be introduced into the combustion chamber along with the sample and oxidizing agent.

Once in the combustion chamber, oxidizable components in the sample are converted into their corresponding oxides and water vapor, where the combustion chamber is maintained at an elevated temperature above an ignition temperature for an oxidizing agent-sample mixture or sufficient to oxidize all or substantially all oxidizable sample components into their corresponding oxides. Generally, the elevated temperature is above about 300° C. In other embodiments, the temperature is above about 600° C. In other embodiments, the temperature is above about 900° C. In other embodiments, the temperature is between about 300° C. and about 2000° C. In other embodiments, the temperature is between about 600° C. and about 1500° C. In other embodiments, the temperature is between about 800° C. and about 1300° C. The combustion apparatuses of this invention can be operated at ambient pressure, at reduced pressure down to ten of millimeters of mercury, or at higher than ambient pressures up to a 1000 or more psia.

The inlet to the combustion zone can include a nebulizer adapted to atomize the sample within the oxidizing agent and an optional inert gas to improve oxidation efficiency.

The term “substantially all” in the context of oxidation means that at least 90% of the oxidizable components in the combustible material have been converted to their corresponding oxides. In other embodiments, the term “substantially all” means that at least 95% of the oxidizable components in the combustible material have been converted to their corresponding oxides. In other embodiments, the term “substantially all” means that at least 98% of the oxidizable components in the combustible material have been converted to their corresponding oxides. In other embodiments, the term “substantially all” means that at least 99% of the oxidizable components in the combustible material have been converted to their corresponding oxides.

Suitable Devices for Use in the Systems of this Invention

Suitable detection system include, without limitation, any device that converts light intensity into a proportional electrical signal. Exemplary devices include a photo-multiplier tube (PMT), Charge-coupled Device (CCD), an Intensitifed Charge Coupled Devise (ICCD) or the like.

Suitable sample supply system include, without limitation, any sample supply system including an auto-sampler, a septum for direct injection, a sampling loop for continuous sampling, an analytical separation system such as a GC, LC, MPLC, HPLC, LPLC, or any other sample supply system used now or in the future to supply samples to analytical instrument combustion chambers or mixture or combinations thereof.

Suitable light sources include, without limitation, metal vapor light sources, gas light sources, excimer light sources, laser light sources or any other light source capable of generating UV light. Exemplary metal vapor light sources or lamps include, without limitation, zinc lamps, cadmium lamps, mercury lamps, mercury halide lamps, and other metal lamps have been used as light sources. Exemplary gas lamps include, without limitation, xenon lamps, deuterium lamps, or other gases the emit UV light.

Suitable excimer light sources for use in this invention are set forth in Table I.

TABLE I
Near and Far Ultraviolet Excimer Gas Emission Species and
Emission Frequency
NEAR ULTRAVIOLET

| | | |
|---|---|---|
| Argon | Gas-Ion | 364 nm (UV-A) |
| XeF | Gas (excimer) | 351 nm (UV-A) |
| N₂ | Gas | 337 nm (UV-A) |
| XeCl | Gas (excimer) | 308 nm (UV-B) |

FAR ULTRAVIOLET

| | | |
|---|---|---|
| Krypton SHG* | Gas-Ion/BBO crystal | 284 nm (UV-B) |
| Argon SHG | Gas-Ion/BBO crystal | 264 nm (UV-C) |
| Argon SHG | Gas-Ion/BBO crystal | 257 nm (UV-C) |
| Argon SHG | Gas-Ion/BBO crystal | 250 nm (UV-C) |
| Argon SHG | Gas-Ion/BBO crystal | 248 nm (UV-C) |
| KrF | Gas (excimer) | 248 nm (UV-C) |
| Argon SHG | Gas-Ion/BBO crystal | 244 nm (UV-C) |
| Argon SHG | Gas-Ion/BBO crystal | 238 nm (UV-C) |
| Argon SHG | Gas-Ion/BBO crystal | 229 nm (UV-C) |
| KrCl | Gas (excimer) | 222 nm (UV-C) |
| ArF | Gas (excimer) | 193 nm (UV-C) |

*SHG means UV Gas-Ion Second Harmonic Generation Light

### Software Detector Signal Adjustment

Background

While not mandatory, typically before use, an instrument of this invention is calibrated to generate a calibration curve. A calibration curve is produced by analyzing or running several samples having known, but different, concentrations of target fluorescently active species of an element, such as SO₂ for sulfur or NO for nitrogen. The measured responses are then plotted producing the calibration curve. A response of an unknown sample is then measured and compared to the calibration curve. The comparison yields a concentration of target species in the unknown sample. This approach, however, assumes that instrument conditions such as an intensity of light generated by the light source, light source drift, etc., remain constant.

Aging effects of a light source often cause the light source output to change, typically to decrease, over time and cause a change, typically an increase, in an output noise level. Both of changes in light output and output noise level directly impact instrument results, reproducability and repeatability. In certain embodiments of the present invention, the system include control features to compensate for changes in light output and noise level without changing the operating conditions of the light source. These types of controls operate well with light sources that include power supplies optimized for the best performance and longevity of the light source and are adapted to enable ideal conditions for lamp operation, while enabling for lamp output or intensity corrections over time, such as a decrease in lamp intensity over time.

One aspect of the control features is to adjust a detector signal by software based on information concerning changes in light source performances over time. This type of software signal adjustment is adapted to significantly increase an interval between calibrations and ideally suited for all types of light sources including lower quality light sources such as Zn lamps and high quality light sources such a excimer lamps. Additionally, digital conditioning of the output of a light source provides additional details on light source performance and additional procedures for software correction of the detector signal based on such conditioning. These type of control systems can also provide information critical for predicting or indicating when lamp servicing or replacement is required, reducing instrument down time—improving maintenance scheduling.

Signal filtering of the light source output is adapted to reduce or minimize the output noise level of the light source resulting in improvement of repeatability of instrument measurements. Such filtering and signal adjustment also serve to lower instrument down time as well as to improve performance of the instrument.

Application

The software detection signal adjustment or conditioning subsystem of the invention includes a light detector/sensor, such as a photodiode, adapted to monitor the light output of the light source. In certain embodiments, the light detector/sensor is located at the back of the fluorescence chamber. However, the light detector/sensor can be located anywhere else, provided it is measuring the light output of the light. The light detector/sensor is adapted to detect and monitor an light output of the light source to produce present light source output characteristics including an intensity value, a noise valve, etc. and to provide continuous information on light source output characteristics. The present light source intensity value and other characteristics detected by the light detector/sensor is converted to a digital signal. The light output intensity value is compared with a stored light source output intensity value. Values for other characteristics captured during the last calibration can also be compared. A difference between the present light source intensity value and the stored light source intensity value is either subtracted from or added to the fluorescent detector signal for an unknown sample to adjust the signal for a shift or change in lamp intensity. This correction is adapted to compensate for a difference between the light source output at the last calibration and actual light source output during each sample analysis.

Furthermore, the signal from light detector/sensor can be digitally processed and digital filtering can be applied to the fluorescent detector signal to reduce or minimize light source noise further improving repeatability of measurements of unknown samples between calibration runs.

### Parts of the System

Light Detector/Sensor

The software feedback assembly includes a stable light detector/sensor such as a stable photodiode used to detect the light source output level and is adapted to convert light intensity into a proportional electrical signal. The light detector/sensor provides a continuous signal for software feedback and detector signal processing.

A/D Converter

The software feedback assembly also includes a high resolution analog to digital converter (e.g., a sigma delta A/D converter). The converter is adapted to convert the light sensor signal into a digital signal for software feedback control through signal digital processing.

Digital Signal Conditioning

The software feedback assembly also includes a microprocessor based unit. The unit is adapted to store a light source output value captured during calibration. The stored light source output value is compared to a present light source output value and based on the comparison, the unit adjusts a signal from the detector such as a photomultiplier to reduce or minimize the aging effects of the light source on measured value of unknown samples. The unit also provides filtering of the signal. The unit can also be adapted to perform other needed functions as required.

### High Voltage Power Supply With Tight Current and Voltage Control

In the present invention, a DC power supply is used to power an excimer light source. The DC power supply is used to ensure that powering of a bridge controller and MOSFET switch unit is well controlled. An input voltage to the controller and the MOSFET switch unit is tightly regulated between about 8V and about 30V. The bridge controller is used for driving gates of the MOSFET switch unit, measuring a excimer light source current and voltage to ensure an over current protection and an over voltage protection and to tightly control excimer light source brightness control. The power supply of this invention is specially designed or adapted to provide best conditions for lamp operation—optimized and controlled operating current, optimized and controlled operating voltage, optimized and controlled operating frequency, etc.

Gate drive outputs are connected directly to the gates of the MOSFET switch unit. The gates are designed to allow current to flow only into a transformer, if one of the high-side switches of the MOSFET switch unit is turned on and at the same time a low-side switch on the other half-bridge is turned on. Maximum output power can be achieved if the turn on time of the high-side switch on one half-bridge exactly overlaps with the turn on time of the low-side switch on the other half bridge of the MOSFET switch unit.

To set the lamp brightness, two basic dimming methods are used: analog dimming and burst dimming. The analog dimming method comprises regulating lamp current via a DC voltage program, where the lamp current is regulated by a current regulator, i.e., the lamp current is controlled directly. The burst dimming method comprising turning the lamp on and off at a low frequency with a certain duty cycle. Burst dimming can be internal (DC voltage programs duty cycle of the generated burst pulses) or external (external PWM signal is directly used for bust dimming).

Dimming circuits are integrated into bridge controller. Each dimming method can be applied independent of each other. Although an bridge controller capable of providing high frequency power to a lamp with analog and burst dimming can be used, the inventors of this invention used a TPS68000 highly efficient phase shift full bridge CCFL controller available from Texas Instruments Incorporated. For additional information the reader is directed to the TI specification publication SLVS524A—October 2005—Revised February 2006.

The bridge controller includes an oscillator component that produces a high frequency output. The internal operating frequency is set by a resistor connected to frequency programming input. Over current protection input is used to monitor a voltage derived from a current sensor. The lamp current is derived from voltage on shunt resistor. Measured voltage is used to regulate lamp current. The lamp voltage is divided in a capacitance divider. Measured voltage is used to regulate lamp voltage and to provide over voltage protection. The high frequency of energy input to the lamp increases lamp output. Alternatively, lamp output can be increase by increasing applied voltage, but increasing voltage is limited by the dielectric breakdown limit of the lamp's envelope.

### Systems

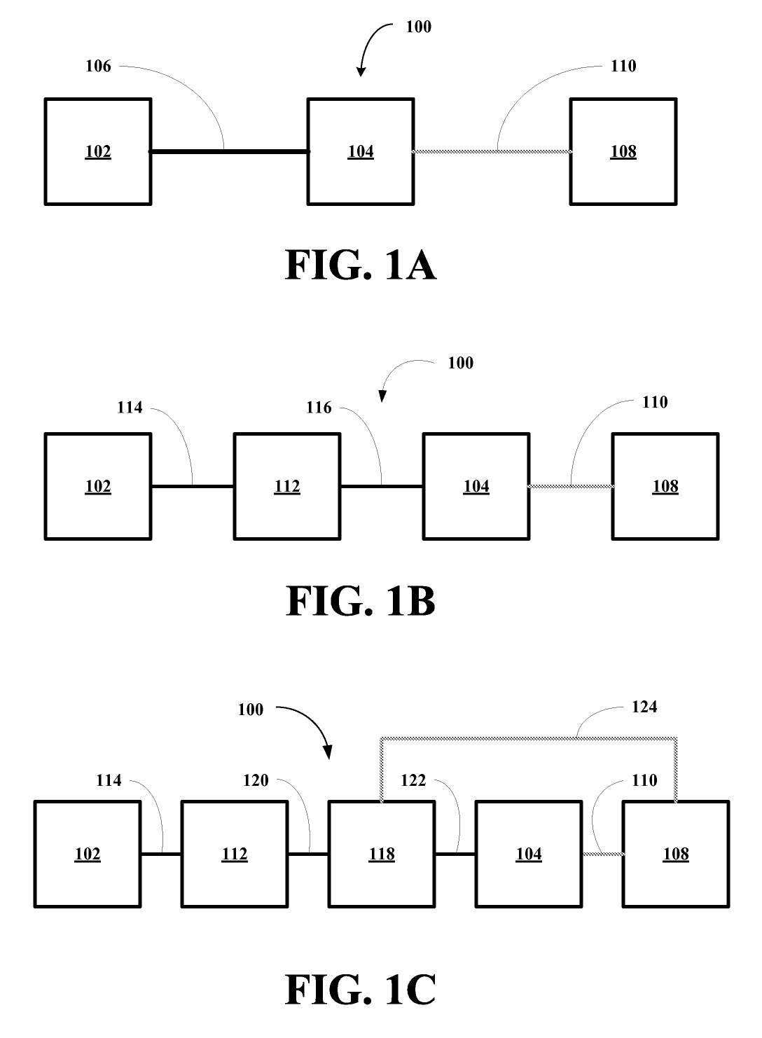

Referring now to FIG. 1A, an embodiment of a system of this invention, generally 100, is shown to include a sample supply or introduction subsystem 102. The system 100 also includes a fluorescent detection subsystem 104 connected to the sample supply or introduction subsystem 102 via a first conduit 106. The system 100 also includes an analyzer subsystem 108 connected to the fluorescent subsystem 104 via a first signal conduit 110.

Another embodiment of a system 100 is shown in FIG. 1B, where the system 100 further includes an oxidation subsystem 112 interposed between the sample supply or introduction subsystem 102. The oxidation subsystem 112 is connected to the sample supply or introduction subsystem 102 via a second conduit 114 and to the fluorescent detection subsystem 104 via a third conduit 116.

Another embodiment of a system 100 is shown in FIG. 1C, the a system 100 further includes a chemiluminescent detection subsystem 118 interposed between the oxidation subsystem 112 and the fluorescent detection subsystem 104. The chemiluminescent detection subsystem 118 is connected to the oxidation subsystem 112 via a fourth conduit 120 and to the fluorescent subsystem 104 via a fifth conduit 122. The chemiluminescent detection subsystem 118 is also connected to the analyzer subsystem 108 via a second signal conduit 124. Optionally, the subsystem 118 may simply include an ozone generator that introduces ozone into the oxidized sample or sample component to reduce or eliminate NO converting it into NO₂, a non-interfering nitrogen oxide. In this type of an alternative arrangement, the subsystem 118 can also include a chamber in which ozone is allowed to mix with the oxidized sample or sample component.

Each subsystem will be described in detail below.

The sample supply or introduction system 102 of use in this invention can be any sample supply system including an auto-sampler, a septum for direct injection, a sampling loop for continuous sampling, an inline injection system, an analytical separation system such as a GC, LC, MPLC, HPLC, LPLC, electrophoresis, or any other sample supply or introduction system used now or in the future to supply or introduce a sample into an analytical instrument of this invention. In the system of FIG. 1A, the sample is introduced directly into the fluorescent detector without any preconditioning such as oxidation. Such systems are generally suitable for testing samples known or expected to contain SO₂. While the systems of FIGS. 1B and 1C rely on sample oxidation to produce SO₂ for subsequent analysis. Of course, the system of FIGS. 1B and 1C can be used for samples that are known or expected to contain SO₂ as well as samples containing non-oxidized sulfur or chemically bound sulfur.

In all the above system embodiments, the analyzer subsystem is generally a digital processing system including a digital processing unit, memory (cache, RAM, ROM, etc.), a mass storage device, peripheral or the like. The analyzer takes as input the output from the detector associated with the detection subsystem such as a PMT and converts the signal into a concentration of an element of interest in the original sample. The data can then be displayed, printed, or the like.

### Fluorescent Detection Subsystems

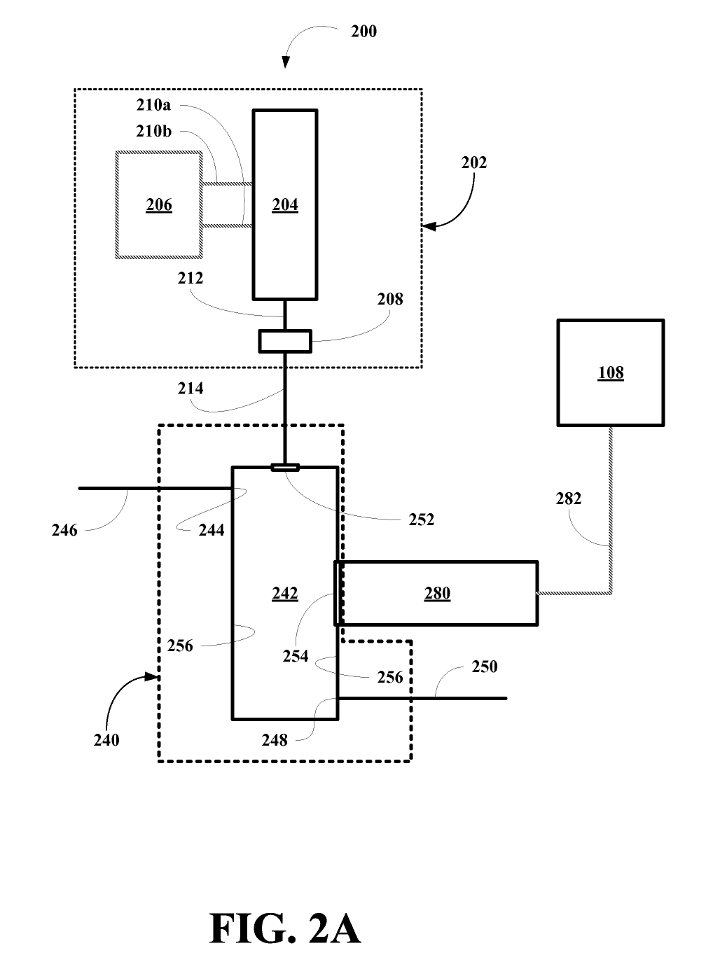

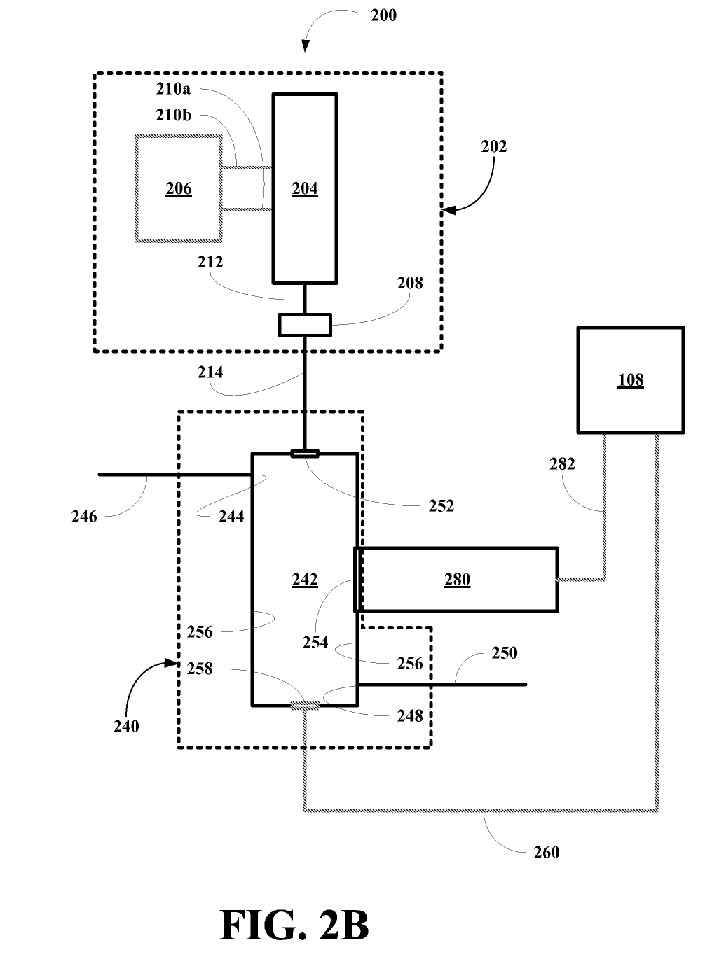

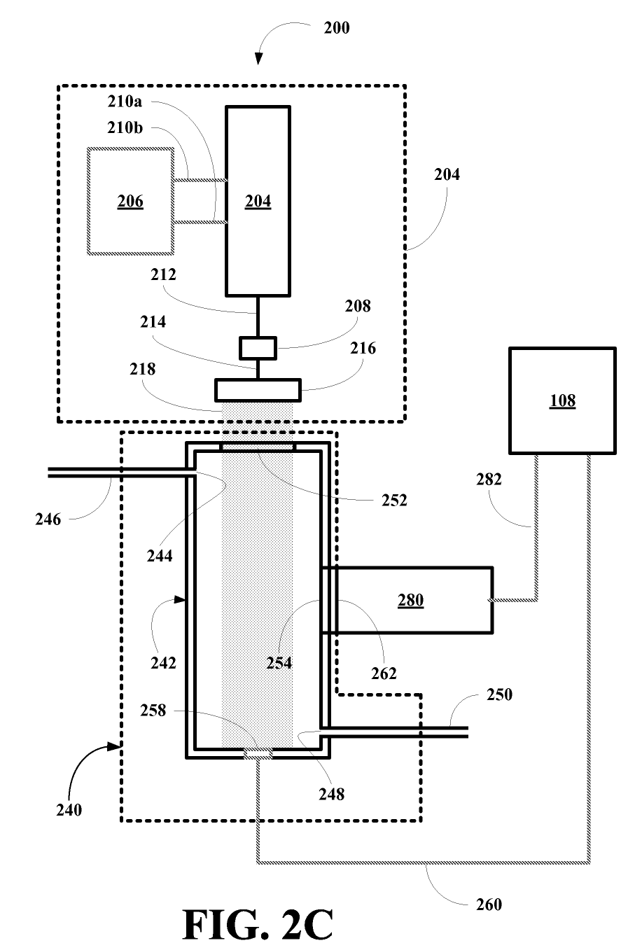

Referring now to FIG. 2A, an embodiment of a UV fluorescent detection subsystem of this invention, generally 200, is shown to include a light source assembly 202, a fluorescent reaction assembly 240, and a detector 280.

The light source assembly 202 includes an excimer light source 204, a power supply 206 and optionally an excitation light filter 208. The power supply 206 is connected to the excimer light source 204 via electrical conduits 210a and 210b. If present, the filter 208 is adapted to receive an excitation light beam 212 and filter the excitation light beam 212 to produce a filtered excitation light beam 214 having a narrow wavelength (or frequency) range of light, i.e., a range narrowly distributed around a desired wavelength. In certain embodiments, the desired wavelength is about 220 nm, which is a wavelength optimal for SO_{2 absorption.}

The fluorescent reaction assembly 240 includes a fluorescent reaction chamber 242. The chamber 242 also includes a sample inlet 244 connected to a sample inlet conduit 246 and a sample outlet 248 connected to a outlet conduit 250. The chamber 242 also includes an excitation light port 252 in optical communication with the excitation light beam 212 or the filtered excitation light beam 214 and a detector port 254 in optical communication with the detector 280. The detector port 254 is situated at a right angle to the excitation port 252; however, the angle can be any angle provided the angle is sufficient to reduce an amount of excitation light from entering the detector port 254. The inner chamber walls 256 can be mirrored to increase an amount of fluorescent light entering the detector port 254 and the detector 280 as set forth in U.S. Pat. Nos. 6,075,609 and 6,636,314, incorporated herein by reference.

The detector 280 is connected to an analyzer subsystem 108 described previously, via a signal conduit 282.

Referring now to FIG. 2B, an embodiment of a UV fluorescent detection subsystem of this invention, generally 200, is shown to include a light source assembly 202, a fluorescent reaction assembly 240, and a detector 280.

The light source 202 includes an excimer light source 204, a power supply 206 and optionally an excitation light filter 208. The power supply 206 is connected to the excimer light source 204 via electrical conduits 210a and 210b. If present, the filter 208 is adapted to receive an excitation light beam 212 and filter the excitation light beam 212 to produce a filtered excitation light beam 214 having a narrow wavelength (or frequency) range of light, i.e., a range narrowly distributed around a desired wavelength. In certain embodiments, the desired wavelength is about 220 nm, which is a wavelength optimal for SO₂ absorption.

The fluorescent reaction assembly 240 includes a fluorescent reaction chamber 242. The chamber 242 includes a sample inlet 244 connected to a sample inlet conduit 246 and a sample outlet 248 connected to an outlet conduit 250. The chamber 242 also includes an excitation light port 252 in optical communication with the excitation light beam 212 or the filtered excitation light beam 214 and a detector port 254 in optical communication with the detector 280. The detector port 254 is situated at a right angle to the excitation port 252; however, the angle can be any angle provided the angle is sufficient to reduce an amount of excitation light from entering the detector port 254. The inner chamber walls 256 can be mirrored to increase an amount of fluorescent light entering the detector port 254 and the detector 280 as set forth in U.S. Pat. Nos. 6,075,609 and 6,636,314, incorporated herein by reference. The chamber 242 can also include an optional light intensity detector/sensor 258, which is connected to the analyzer 108 via a signal conduit 260 for use in the software feedback control described above.

The detector 280 is connected to an analyzer subsystem 108 described previously, via a signal conduit 282.

Referring now to FIG. 2C, another embodiment of a UV detection subsystem of this invention, generally 200, is shown to include a light source assembly 202, a fluorescent reaction assembly 240, and a detector 280.

The light source 202 includes an excimer light source 204 and a power supply 206 and an excitation light filter 208. The power supply 206 is connected to the excimer light source 204 via electrical conduits 210a and 210b. The filter 208 is adapted to receive an excitation light beam 212 and filter the excitation light beam 212 to produce a filtered excitation light beam 214 having a narrow wavelength (or frequency) range of light, i.e., a range narrowly distributed around a desired wavelength. In certain embodiments, the desired wavelength is about 220 nm, which is a wavelength optimal for SO₂ absorption. The filtered excitation light beam 214 then passes through a spreader or collimator 216 to form a spread beam 218.

The fluorescent reaction assembly 240 includes a fluorescent reaction chamber 242. The chamber 242 includes a sample inlet 244 connected to a sample inlet conduit 246 and a sample outlet 248 connected to an outlet conduit 250. The chamber 242 also includes an excitation light port 252 in optical communication with the spread beam 218 and a detector port 254 in optical communication with the detector 280. The detector port 254 is situated at a right angle to the excitation port 252; however, the angle can be any angle provided the angle is sufficient to reduce an amount of excitation light from entering the detector port 254. The inner chamber walls 256 can be mirrored to increase an amount of fluorescent light entering the detector port 254 and the detector 280 as set forth in U.S. Pat. Nos. 6,075,609 and 6,636,314, incorporated herein by reference. The chamber 242 can also include an optional light intensity detector/sensor 258, which is connected to the analyzer 108 via a signal conduit 260 for use in the software feedback control described above. The fluorescent reaction chamber 242 can also include a fluorescent light filter 262.

The detector 280 is connected to an analyzer subsystem 108 described previously, via a signal conduit 282.

In those system designed to detect both nitrogen and sulfur, then the oxidized sample can be split into two parts, one part going to a sulfur detection system and the other part going to a nitrogen detection system. In those systems having a fluorescent subsystem and a chemiluminescent subsystem, the chemiluminescent subsystem measured nitrogen in the form NO, while the chemiluminescent subsystem measures sulfur in the form of SO_{2.}

### High Voltage Power Supply

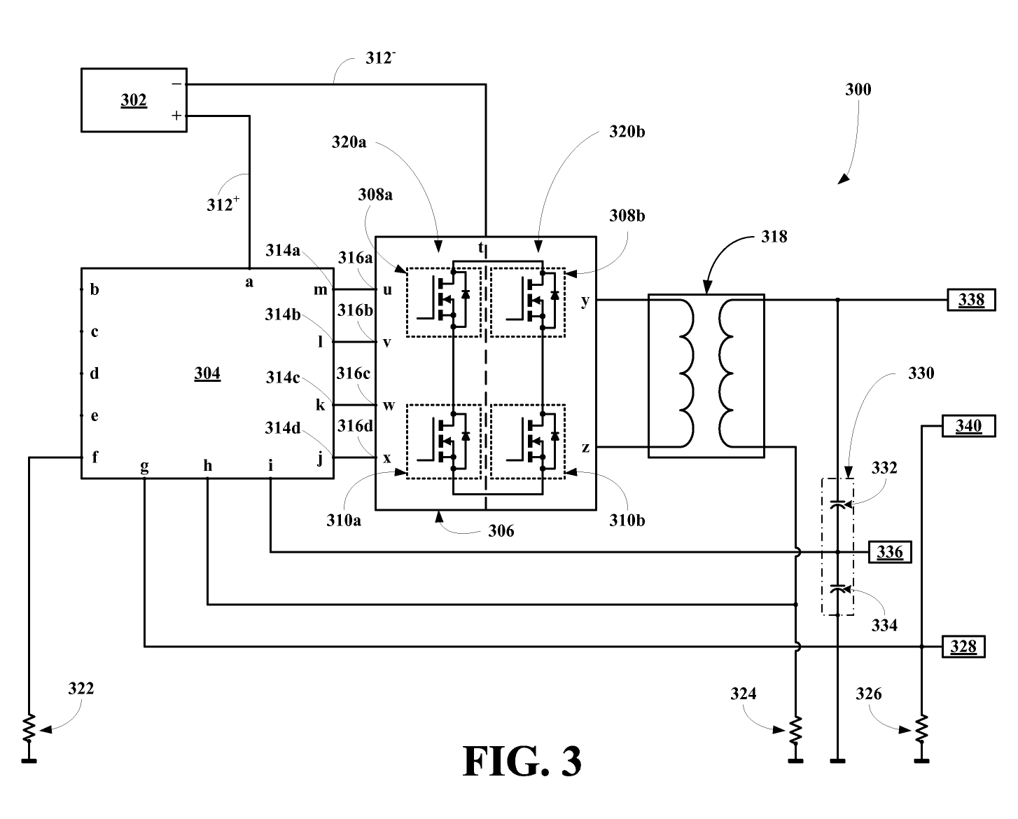

Referring now to FIG. 3, an embodiment of a feedback/closed loop control subsystem of this invention, generally 300, a DC power supply 302, which is used as the main power for the light source such as the excimer light source 204. The DC power supply 302 is used to supply power to a bridge controller 304 and MOSFET switch unit 306. The bridge controller 304 includes thirteen input and output channels a-m. The switch unit 306 includes switches 308a &b and 310a &b. The switch unit 306 also includes seven input and output channels t-z. The DC power supply 302 is adapted to supply a well controlled initial voltage to the bridge controller 304 at the input channel a via supply line 312⁺ and to the MOSFET switch unit 306 at the input channel t via supply line 312⁻. An input voltage to the controller 304 and the MOSFET switch unit 306 is tightly regulated to a value between about 8V and about 30V. The bridge controller 304 includes gate drive outputs 314a-d used for driving gates 316a-d of the MOSFET switch unit 306. The gates 314a-d and 316a-d are adapted to measure a light source current and voltage to ensure over current protection and over voltage protection and to tightly control light source brightness.

The bridge controller channels a-m are defined as follows:

TABLE I
Bridge Controller Channel Descriptions

| ID | Description |
|---|---|
| a | DC Input Voltage |
| b | Chip Enable ON/OFF |
| c | Analog dimming input (0 to 3.3 V DC) |
| d | Internal burst dimming input (0 to 5 V DC) |
| e | External burst dimming input (PWM signal) |
| f | Operating frequency programming |
| g | Light source current regulation |
| h | Over current protection |
| i | over voltage protection/Light source voltage regulation |
| j | Gate drive output 314d |
| k | Gate drive output 314c |
| l | Gate drive output 314b |
| m | Gate drive output 314a |

The switch unit channels t-z are defined as follows:

TABLE II
Switch Unit Channel Descriptions

| ID | Description |
|---|---|
| t | DC Input Voltage |
| u | Driving gate 316a |
| v | Driving gate 316b |
| w | Driving gate 316c |
| x | Driving gate 316d |
| y | Transformer positive voltage output |
| z | Transformer negative voltage output |

The gate drive outputs 314a-d are connected directly to the gates 316a-d of the MOSFET switch unit 306. The gates 314a-d and the gates 316a-d are designed to allow current to flow only into a transformer 318, if a switch 308a is turned on in one half bridge 320a and at the same time that a switch 310a on the other half-bridge 320b is turned on. Maximum output power can be achieved if a turn on time of the switch 308a, 308b on one half-bridge 320a, 320b exactly overlaps with a turn on time of the switch 310a, 310b on the other half bridge 320b, 320a.

To set the light source 204 brightness, the apparatus and methods of this invention utilize two basic dimming methods. The first dimming method comprises analog dimming, where a DC voltage programs the light source 204 current regulated by a current regulator so that the light source 204 current is controlled directly. The second dimming method comprises burst dimming, where the light source 204 is turned ON and OFF at a low frequency with a certain duty cycle. The burst dimming method can be internal (i. e., the DC voltage programs the duty cycle of the generated burst pulses) or external (i.e., an external PWM signal is directly used for bust dimming). The dimming circuits are integrated into bridge controller 304. The dimming methods can be applied independent of each other.

The high voltage power supply 300 also includes a frequency setting resistor 322 adapted to control an internal operating frequency, which serves as the frequency programming input channel f of the bridge controller 304. The over current protection input is used to monitor a voltage derived from a current sensor 324. The light source current is derived from a voltage on a shunt resistor 326. A current measuring apparatus 328 measures a current used for light source current regulation. The light source voltage is derived from a capacitance divider 330 including a first capacitor 332 and a second capacitor 334. A voltage measuring apparatus 336 measures a voltage used for lamp voltage regulation and light source over voltage protection. The high voltage power supply 300 produces a high voltage outputs 338 and 340.

### Oxidation Subsystems

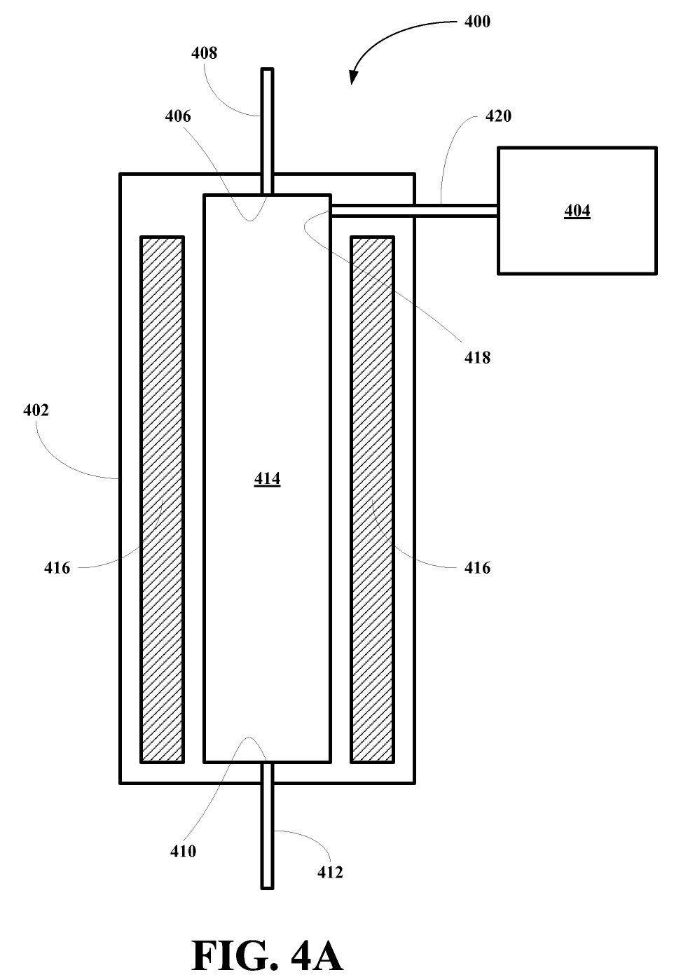

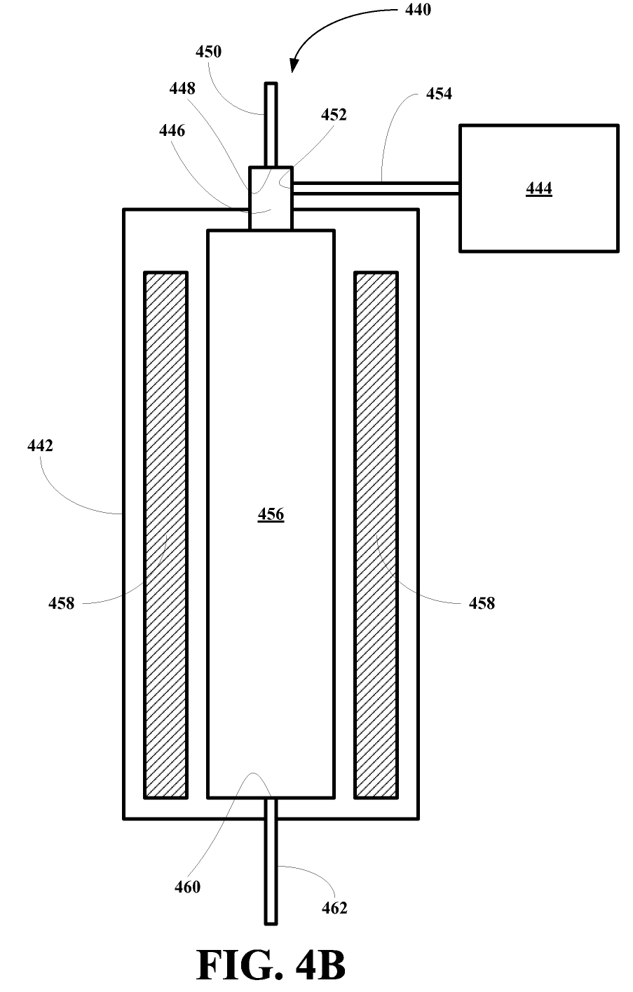

Referring now to FIG. 4A, an embodiment of an oxidizing or combustion subsystem of this invention, generally 400, is shown to include a furnace 402 and an oxidizing agent supply 404.

The furnace 402 includes a sample inlet 406 connected to a sample input conduit 408 and an oxidized sample outlet 410 connected to an oxidized sample conduit 412. The furnace 402 also includes an oxidizing zone 414 and a heater 416. The furnace 402 also includes an oxidizing agent inlet 418 connected to an oxidizing agent conduit 420.

Referring now to FIG. 4B, an embodiment of an oxidizing subsystem of this invention, generally 440, is shown to include a furnace 442 and an oxidizing agent supply 444.

The furnace 442 includes a nebulizer 446 including a sample inlet 448 connected to a sample input conduit 450 and an oxidizing agent inlet 452 connected to an oxidizing agent conduit 454. The furnace 442 also includes an oxidizing zone 456 and a heater 458. The furnace 442 also includes an oxidized sample outlet 460 connected to an oxidized sample conduit 462.

Referring now to FIG. 4C, an embodiment of an oxidizing subsystem of this invention, generally 470, is shown to include a furnace 472 and an oxidizing agent supply 474.

The furnace 472 includes a nebulizer 476 including a sample inlet 478 connected to a sample input conduit 480 and an oxidizing agent inlet 482 connected to an oxidizing agent conduit 484. The furnace 472 also includes an oxidizing zone 486 and a heater 488. The furnace 472 also includes a second oxidizing agent inlet 490 connected to a second oxidizing agent conduit 492. The furnace 472 also includes an oxidized sample outlet 494 connected to an oxidized sample conduit 496. The oxidizing zone 486 includes two static mixers 498. The two static mixers 498 and the second oxidizing agent inlet 490 are adapted to improve combustion efficiency.

### Chemiluminescent Detection Subsystems

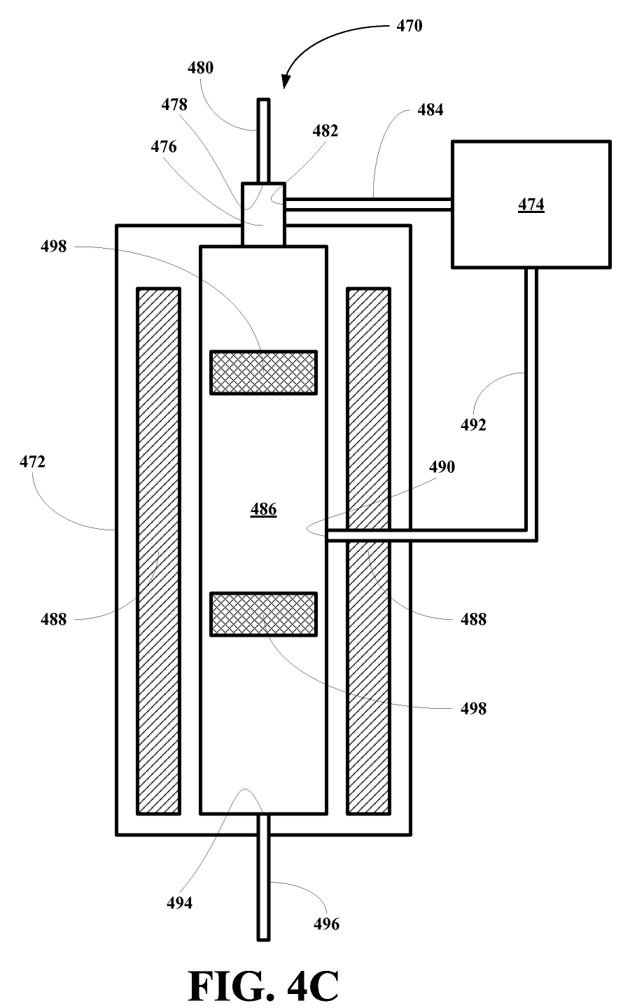

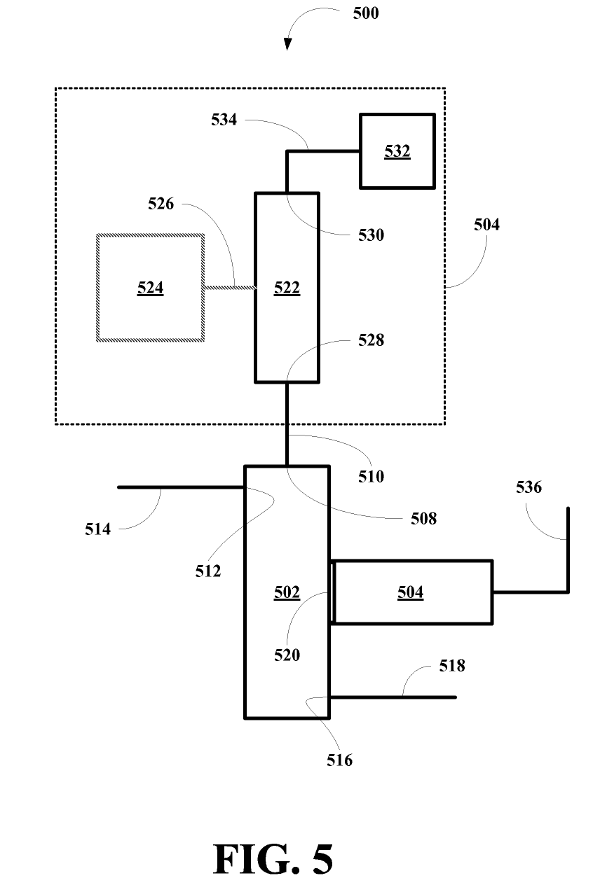

Referring now to FIG. 5, an embodiment of a chemiluminescent subsystem of this invention, generally 500, is shown to include an ozone reaction chamber 502, an ozone source 504 and a detector 506.

The ozone reaction chamber 502 includes an ozone inlet 508 connected to an ozone conduit 510. The ozone reaction chamber 502 also includes a sample inlet 512 connected to an sample conduit 514. The ozone reaction chamber 502 also includes a sample outlet 516 connected to a sample outlet conduit 518. The ozone reaction chamber 502 also includes a detector port 520. The inner chamber walls can be mirrored to increase an amount of chemiluminescent light entering the detector port 520 and the detector 504 as more fully described in U.S. Pat. No. 6,075,609 and 6,636,314, incorporated herein by reference.

The ozone source 504 includes an ozone generator 522 and an ozone generator power supply 524, where the power supply 524 is connected to the ozone generator 522 via an electric conduit 526. The ozone generator 522 includes an ozone outlet 528 connected to the ozone conduit 510. The ozone generator 522 also includes an oxygen or air inlet 530 connected to an oxygen or air supply 532 via an oxygen or air electrical conduit 534. The ozone source 504 is adapted to supply sufficient ozone to the ozone reaction chamber to cause NO to be oxidized to a chemiluminescently active species and reduce nitrogen interference with SO₂ detection in the fluorescent subsystem.

The detector 504 is connected to an analyzer subsystem described previously, via a data conduit 536.

Alternatively, ozone can simply be added to the oxidized sample or sample components to remove any NO so that NO cannot interfere with SO₂ detection as more fully described in U.S. Pat. No. 7,244,395, incorporated herein by reference.

### Excimer Light Sources

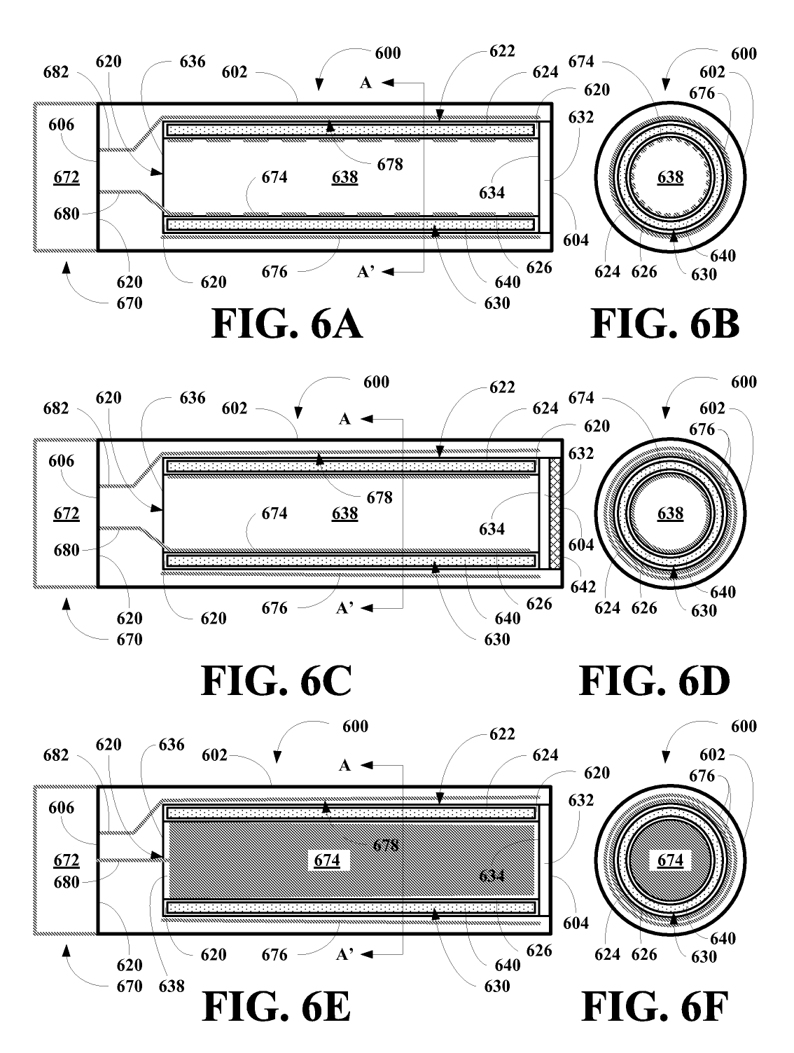

Referring now to FIGS. 6A & B, an embodiment of an excimer light source subsystem of this invention, generally 600, is shown to include housing 602, an excimer light source assembly 620, and a light source power supply assembly 670, where the housing surrounds the excimer light source assembly 620.

The excimer light source assembly 620 includes a dielectric barrier gas enclosure 622. The enclosure 622 includes an outer dielectric barrier 624, an inner dielectric barrier 626, and end dielectric barriers 628, defining an enclosure interior 630. The assembly 620 also includes an output light window 632 situated an a distal end 634 of the enclosure 622 and disposed at a distal end 604 of the housing 602, while a proximal end 636 is situated near a proximal end of the housing 606. The assembly 620 also includes a hollow interior region 638, in which an inner electrode can be disposed as described below. The interior 630 is adapted to be filled with an excimer gas 640 that produces light of a narrow frequency range centered around a desired frequency. Of course, all excimer so produce some light centered around other frequencies. Often this other light can contribute to unwanted background in the fluorescent chamber or that may excite other species that may be present in the fluorescent chamber other than SO₂. If this is the case, then the assembly 620 can also includes a filter as described in a subsequent embodiment.

The power supply assembly 670 includes power supply 672, an inner electrode 674 comprising a mesh of a conductive material and an outer electrode 676 comprising a solid conductive material (i.e., in the form of a shell or hollow tube) and including an inner mirrored surface 678. The inner electrode 674 is connected to the power supply 672 via a first conductive conduit 680. The outer electrode 676 is connected to the power supply 672 via a second conductive conduit 682. The first conductive conduit 680 and the second conductive conduit 682 are connected to outputs of the power supply 672. The power supply 672 is adapted to produce an output capable of producing excimer gas species 640 in the interior 630 of the gas enclosure 622. The output is generally in the form of a high frequency waveform output optimized to produce a stable light output. The waveform is oscillator and can comprise a pure sinusoidal waveform, a combination of sinusoidal waveforms (square waves, etc.) or any other continuously oscillatory waveforms capable of producing a stable excimer light source output.

Referring now to FIGS. 6C & D, another embodiment of an excimer light source subsystem of this invention, generally 600, is shown to include housing 602, an excimer light source assembly 620, and a light source power supply assembly 670, where the housing surrounds the excimer light source assembly 620.

The excimer light source assembly 620 includes a dielectric barrier gas enclosure 622. The enclosure 622 includes an outer dielectric barrier 624, an inner dielectric barrier 626, and end dielectric barriers 628, defining an enclosure interior 630. The assembly 620 also includes an output light window 632 situated an a distal end 634 of the enclosure 622 and disposed at a distal end 604 of the housing 602, while a proximal end 636 is situated near a proximal end of the housing 606. The assembly 620 also includes a hollow interior region 638, in which an inner electrode can be disposed as described below. The assembly 620 also includes a light filter 642 adapted to reduce light not centered about a desired frequency. The interior 630 is adapted to be filled with an excimer gas 640 that produces light of a narrow frequency range centered around a desired frequency. Of course, all excimer so produce some light centered around other frequencies. Often this other light can contribute to unwanted background in the fluorescent chamber or that may excite other species that maybe present in the fluorescent chamber other than SO₂. If this is the case, then the assembly 620 can also includes a filter as described in a subsequent embodiment.

The power supply assembly 670 includes power supply 672, an inner electrode 674 comprising a solid conductive material (i.e., in the form of a shell or hollow tube) and an outer electrode 676 comprising a solid conductive material (i.e., in the form of a shell or hollow tube) and including an inner mirrored surface 678. The inner electrode 674 is connected to the power supply 672 via a first conductive conduit 680. The outer electrode 676 is connected to the power supply 672 via a second conductive conduit 682. The first conductive conduit 680 and the second conductive conduit 682 are connected to opposed poles of the power supply 672. The power supply 672 is adapted to produce an output capable of producing excimer gas species 640 in the interior 630 of the gas enclosure 622. The output is generally in the form of a high frequency waveform output optimized to produce a stable light output. The waveform is oscillator and can comprise a pure sinusoidal waveform, a combination of sinusoidal waveforms (square waves, etc.) or any other continuously oscillatory waveforms capable of producing a stable excimer light source output.

Referring now to FIGS. 6E & F, another embodiment of an excimer light source subsystem of this invention, generally 600, is shown to include housing 602, an excimer light source assembly 620, and a light source power supply assembly 670, where the housing surrounds the excimer light source assembly 620.

The excimer light source assembly 620 includes a dielectric barrier gas enclosure 622. The enclosure 622 includes an outer dielectric barrier 624, an inner dielectric barrier 626, and end dielectric barriers 628, defining an enclosure interior 630. The assembly 620 also includes an output light window 632 situated an a distal end 634 of the enclosure 622 and disposed at a distal end 604 of the housing 602, while a proximal end 636 is situated near a proximal end of the housing 606. The assembly 620 also includes a hollow interior region 638, in which an inner electrode can be disposed as described below. The assembly 620 also includes a light filter 642 adapted to reduce light not centered about a desired frequency. The interior 630 is adapted to be filled with an excimer gas 640 that produces light of a narrow frequency range centered around a desired frequency. Of course, all excimer so produce some light centered around other frequencies. Often this other light can contribute to unwanted background in the fluorescent chamber or that may excite other species that maybe present in the fluorescent chamber other than SO₂. If this is the case, then the assembly 620 can also includes a filter as described in a subsequent embodiment.

The power supply assembly 670 includes power supply 672, an inner electrode 674 comprising a solid rod conductive material and an outer electrode 676 comprising a solid conductive material (i.e., in the form of a shell or hollow tube) and including an inner mirrored surface 678. The inner electrode 674 can also be mirrored and tapers as shown in FIG. 6E or untapered as shown in FIG. 6F. The tapered electrode 674 tapers towards the end 604. The taper is adapted to further increase light exciting the window 632 acting in concert with the taper of the outer electrode 676. The inner electrode 674 is connected to the power supply 672 via a first conductive conduit 680. The outer electrode 676 is connected to the power supply 672 via a second conductive conduit 682. The first conductive conduit 680 and the second conductive conduit 682 are connected to opposed poles of the power supply 672. The power supply 672 is adapted to produce an output capable of producing excimer gas species 640 in the interior 630 of the gas enclosure 622. The output is generally in the form of a high frequency waveform output optimized to produce a stable light output. The waveform is oscillator and can comprise a pure sinusoidal waveform, a combination of sinusoidal waveforms (square waves, etc.) or any other continuously oscillatory waveforms capable of producing a stable excimer light source output.

Although three different inner electrodes 674 have been shown, the exact nature of the inner electrode can be any combination of these three general types of electrodes or any other type of electrode that can be disposed in the interior region 638 adjacent the inner dielectric barrier 626. The outer electrode 676 can also be constructed to have straight portions and tapered portions provided that the interior surface is mirrored to reflect UV light between the interior surfaces of the outer electrode.

### Excimer Light Source Output

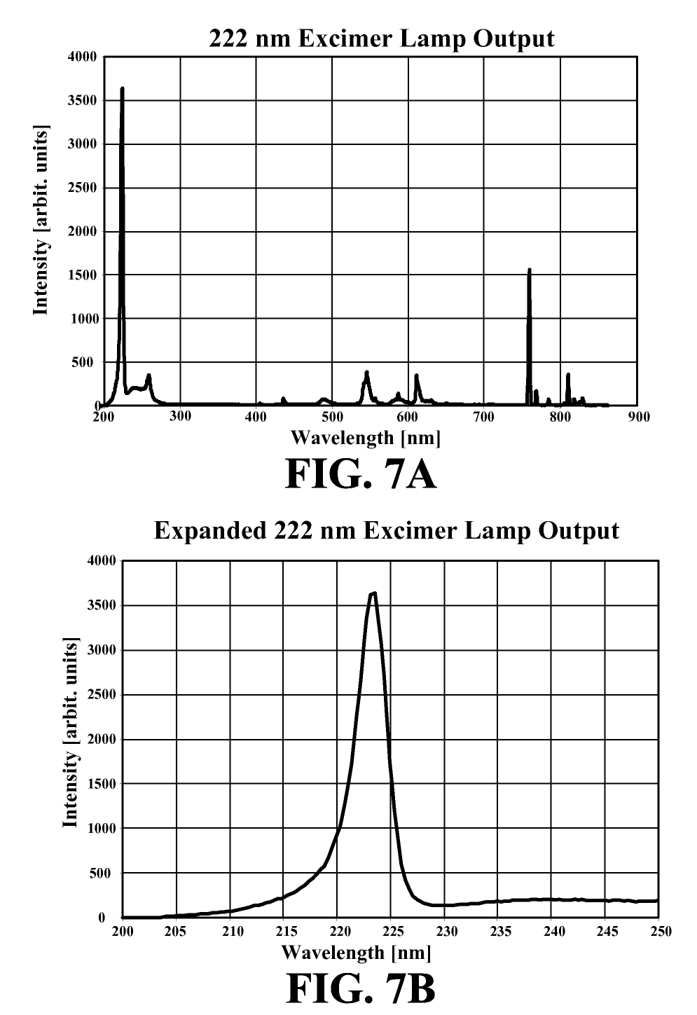

Referring now to FIGS. 7A & B, light output spectra of an embodiment of an excimer light source subsystem of this invention are shown. Looking at FIG. 7A, the output spectrum is shown for the light source from 200 nm to 900 nm. Looking at FIG. 7B, the output spectrum is shown in an expanded format focusing on the light of wavelength between 200 nm to 250 nm. It clear from both spectra that the lamp or light source produces a large signal centered at 222 nm. The excitation light filters are designed to reduce or to cut off all wavelength greater than about 225 nm. In other embodiments, the filters cut off light having wavelengths greater than 224 nm. The reason for producing light of a narrow wavelength centered at 222 nm and having a range between about 205 nm and about 225 nm or in other embodiments between 205 nm and 224 nm is to reduce or eliminate the concurrent excitation of NO that may be present in the sample. The absorption spectra and emission spectra of SO₂ and NO occur in the same UV region of the electromagnetic spectrum between about 190 nm and about 230 nm. However, the NO absorption spectrum consists of a number of relatively broadly spaced sharp absorption peaks, while the SO₂ absorption spectrum consists of many more narrowly spaced sharp absorption peaks. Light narrowly centered about 222 nm is situated between two absorption peaks of NO, while overlapping with a SO₂ absorption peak. Thus, light having a narrow wavelength range centered at 222 nm such as light from a filtered excimer light source or even more ideally from a laser that may be available in the future, is well suited for exciting SO₂ absorption, while reducing or minimizing NO excitation and thus reduce NO interference with SO₂ detection. As set forth in U.S. Pat. No. 7,244,395, the addition of ozone to the sample prior to irradiation with the UV light in the fluorescent reaction chamber can reduce or eliminate NO interference by destroying NO, the disclosure of which is incorporated herein by reference. Thus, in one embodiment of this invention, the NO chemiluminescence apparatus is simply an ozone introduction unit designed to convert any NO to NO₂, a nitrogen oxide that is inert to UV light centered at 222 nm.

All references cited herein are incorporated by reference for all purposed permitted by law, even if certain cited references are incorporated by reference at the instance of referal. Although the invention has been disclosed with reference to its preferred embodiments, from reading this description those of skill in the art may appreciate changes and modification that may be made which do not depart from the scope and spirit of the invention as described above and claimed hereafter.

We claim:

1. An apparatus for analyzing a sample or sample component comprising:
a sample supply system adapted to supply a sample,
a detection system including:
an light source assembly having,
an excimer light source, and
a high voltage power supply,
where the excimer light source produces excitation light having a narrow wavelength or frequency range centered at an optimal absorption frequency of the fluorescently active species to be detected,
a detection chamber having
a sample inlet adapted to receive the sample, and
a sample outlet adapted to vent the sample from the chamber,
an excitation light inlet in optical communication with the excimer light source and adapted to receive excitation light into the chamber,
a fluorescent light outlet adapted to receive a portion of fluorescent light generated by fluorescently active species in the chamber excited by the excitation light,
a detector in optical communication with the light outlet and adapted to detect an intensity of fluorescent light passing through the light outlet and converting an intensity of the light into a proportional electric current signal, and
an analyzer in electrical communication with the detector and adapted to convert the electric current signal from the detector into a concentration of the fluorescently active species in the chamber and into a concentration of a corresponding element in the sample.

2. The apparatus of claim 1, further comprising:
a combustion system interposed between the sample supply system and the detection system, where the combustion system includes:
a combustion zone,
an oxidizing agent supply subsystem,
an sample inlet,
at least one oxidizing agent inlet,
an outlet connected to the sample inlet of the detection chamber, and
a heater adapted to maintain the combustion zone at an elevated temperature,
where the combustion system is adapted to oxidize substantially all oxidizable components in the sample into their corresponding oxides.

3. The apparatus of claim 1, wherein the sample comprises a hydrocarbon containing sample, a fuel, a chemical reactor stream, a refinery stream, or a flue gas stream.

4. The apparatus of claim 3, wherein the fuel is selected from the group consisting of gasoline, kerosine, jet fuel, diesel fuel, other hydrocarbon based fuels and mixtures or combinations thereof.

5. The apparatus of claim 1, wherein the element is selected from the group consisting of nitrogen, sulfur and mixtures or combinations thereof.

6. The apparatus of claim 5, wherein the fluorescently active species is sulfur dioxide, the excimer light source is a krypton-chloride gas excimer light source and the wavelength range is centered at about 222 nm.

7. The apparatus of claim 1, wherein the sample supply system is selected from the group consisting of an auto-sampler, a septum for direct injection, a sampling loop for continuous sampling, an analytical separation system and mixture or combinations thereof.

8. The apparatus of claim 9, wherein the analytical separation system is selected from the group consisting of a GC, an LC, an MPLC, an HPLC, an LPLC, electrophoresis apparatus, and mixtures or combinations thereof.

9. The apparatus of claim 1, further comprising:
a software detector signal feedback correction assembly comprising a light sensor adapted to continuously monitor output light characteristic values of the light source and a processing unit adapted to receive current light source output characteristic values, to compare current values to a set of light source output characteristic valves derived during an instrument calibration, to produce change values and to adjust the detector signal based on the change values.

10. The apparatus of claim 1, wherein the high voltage power supply comprises:
a DC power supply producing an input DC voltage,
a bridge controller,
a switch unit,
a transformer,
a frequency setting resistor,
a current sensor
a voltage divider,
a voltage measuring apparatus,
a shunt resistor and
a current measuring apparatus,
where the bridge controller controls the voltage and current being supplied to the excimer light source so that an excitation light intensity is maintained at a desired level between calibrations.

11. A method comprising the steps of:
feeding a sample to an apparatus comprising:
a sample supply unit;
an oxidizing agent supply unit;
a furnace including:
a combustion zone and
a heater adapted to maintain the combustion zone at a temperature sufficient to oxidize oxidizable components of the sample into their corresponding oxides and water;
a detection system including:
a detection chamber,
a transfer tube interconnecting the furnace and the detection chamber,
an excimer light source in optical communication with the detection chamber
for producing excitation light a narrow wavelength or frequency range centered at an optimal absorption frequency of the fluorescently active species to be detected,
a photo detector in optical communication with the detection chamber for detecting a portion of fluorescent light generated by fluorescently active species in the chamber excited by the excitation light, and
an analyzer adapted to convert an output of the photo detector into a concentration in the sample of an element of the at least one oxide,
oxidizing the oxidizable components of the sample into their corresponding oxides and water forming an oxidized mixture;
forwarding the oxidized mixture to the detection chamber,
exciting an oxide in the oxidized mixture with the excitation light to produce the fluorescently active species,
detecting the portion of the fluorescent light generated by fluorescently active species in the chamber excited by the excitation light, and
determining a concentration of an element in the sample from the portion of the fluorescent light generated by fluorescently active species in the chamber excited by the excitation light.

12. The method of claim 11, further comprising:
adjusting the detector signal based on light output change values determined by a software detector signal feedback correction assembly comprising a light sensor adapted to continuously monitor output light characteristic values of the light source and a processing unit adapted to receive current light source output characteristic values, to compare current values to a set of light source output characteristic valves derived during an instrument calibration, and to produce the change values.
